(19) United States
(12) Patent Application Publication
(10) Pub. No.: US 2021/0127608 A1
(43) Pub. Date: May 6, 2021

(54) SURFACE-MOUNTABLE HYDROPONIC GARDENING SYSTEM AND GROW LIGHT PANEL APPLICATION

(71) Applicant: Christopher Hardgrove, Neshanic Station, NJ (US)

(72) Inventor: Christopher Hardgrove, Neshanic Station, NJ (US)

(21) Appl. No.: 17/071,628

(22) Filed: Oct. 15, 2020

Related U.S. Application Data
(60) Provisional application No. 62/927,901, filed on Oct. 30, 2019.

(51) Int. Cl. A01G 31/06; A01G 7/04

(52) U.S. Cl. CPC A01G 31/06; A01G 2031/006; A01G 7/045

(57) ABSTRACT

A surface-mountable vertical hydroponic garden and curved lighting application is provided. The device is mountable to a wall making it more accessible and adjustable to the user and clears horizontal surface spaces. The symmetrical hydroponic gardening tower provides a continuous nutrient soluble water circulatory system to two identical growing site columns. The front face remains open to connect to an adjustable curved lighting panel application. The vertical grow lights are affixed to the interior space of the panels providing focus and proximity to the plants, reducing light dispersion and reducing direct light lighting to the user.

### CROSS-REFERENCE TO RELATED APPLICATIONS

This application claims priority to U.S. Provisional Patent Application Ser. No. 62/927,901, filed Oct. 29, 2019, entitled A VERTICAL WALL HANGING HYDROGARDEN AND BACK-LIT LED CURVED LIGHT PANEL FOR INDOOR USE, which is hereby incorporated by reference in its entirety.

### FIELD OF THE SPECIFICATION

The present application generally relates to a hydroponic growing unit with a growing tower and light system. More precisely, the present invention relates to devices for vertical plant cultivation, surface-mounted gardening and indoor gardening.

### BACKGROUND OF THE INVENTION

Hydroponics is a method of growing terrestrial plants without soil in mineral nutrient solutions, using water for circulation and delivery. A hydroponic garden typically includes a water reservoir, a water pump to distribute the nutrient solution, rows of plant access sites and access to sunlight or artificial grow lighting to produce the rays needed for plant growth. Plants are supported by porous plant grow mediums such as rockwool fiber and suspended in plant site holes using net cups. These grow mediums both hold the plants and absorb nutrient-filled water for the plant.

Hydroponics use less water than traditional soil methods and can be brought indoors for year-round growth given the plants have access to enough light. Larger hydroponic systems use vertical towers to save space and oxygenate the water. These systems circulate the nutrient soluble water from the bottom reservoir to the top and distribute down to each plant site. The water system is typically recycling within the column in a vertical design that sits on the ground.

Simmons (U.S. Pat. No. 8,250,809 B2)¹ discloses a self-contained apparatus utilizing a water pump and reservoir in a single distribution pipe for growing aeroponically, a division of hydroponics in which plant roots are in an air or mist environment.

VanLente (U.S. Pat. No. 9,210,846 B2)² discloses a vertical plant grower with channels of open pockets in which the stand must move to orient plants to sunlight. Lin (U.S. Pat. No. 2012/0066972 A1)³ discloses a moveable plant grower vertical apparatus with large reservoir and an n-shaped vertical frame. Urai (U.S. Pat. No. 4,268,994)⁴ discloses a three-dimensional planter also using a reservoir and can be suspended.

Bryan (U.S. Pat. No. 7,055,282B2)⁵ discloses a vertical planter apparatus having a hollow modular column stacked on top of a water reservoir that sits on the ground. Plant access hole sites are found throughout the entirety of vertical space of the column. A water distribution system delivers water to an upper reservoir mounted atop a central conduit. The water runs down through the length of each column module and is directed through offshoots of the conduit into the growth medium of each plant site. Leroux (U.S. Pat. No. 4,218,847A)⁶ discloses another free standing hydroponic apparatus comprising plant trays and an array of nutrient feed apertures. Gottlieb (U.S. Pat. No. 7,516,574 B2)⁷ discloses a vertical hydroponic garden utilizing radiating planter ports filled with plant media. Baker (U.S. Pat. No. 2011/0258925 A1)⁸ discloses a hydroponic vertical planter that can be mounted to a wall or vertical support. Blank (U.S. Pat. No. 1,036,594B2)⁹ discloses an aeroponic vertical growing system in which interconnected growing pots have an overhead support to suspend each column and can use a turning mechanism for uniformity of illumination. In these cases, plants would need a series of artificial lighting or to be placed outside for access to proper sunlight.

Ware (U.S. Pat. No. 6,615,542)¹⁰ discloses a system comprising multiple columns of hydroponic plant growth units in which the plant access holes face the center internal space to accommodate a light source.

Haggarty (U.S. Pat. No. 20170311554A1)¹¹ discloses a suspended horizontal artificial lighting device for growing horticulture indoors with a mixture of LED lights and a timing method to be applied for more healthy plant growth. The height of the lighting device can only be adjusted to a single horizontal level for single plant growth or average plant growth amongst multiple plants.

Graven (U.S. Pat. No. 6,178,692B1)¹² discloses another horizontal lighting system for use with a vertical hydroponic tower garden. The lighting system tilts and adjusts to plant growth needs by rotating on a horizontal axis. This horizontal lighting system must be attached to an additional horizontal frame and does not connect to the hydroponic garden that sits on a flat surface or ground.

Rakestraw (U.S. Pat. No. 4,250,666A)¹³ discloses a larger stand-alone supporting structure for growing plants that incorporates grow lighting with a plurality of rotatable or fixed trays mounted to a central support. The lighting system consists of two vertical grow lights for the trays of plants. Chien (U.S. Pat. No. 2008/0259615 A)¹⁴ discloses a surface mounted device with LED light with a variety of accessories. Grow lighting is designed to be very bright and these lighting systems will lose and disperse a large portion of that light into the room.

Prior hydroponic gardens utilize the vertical space for plant growth without acknowledging the needs of artificial light in a smaller scale application. With the addition of grow lights to systems, a lot of light is dispersed and wasted into the room. This light is very bright to users as the lighting must replicate the needs of plants from the sun. Accordingly, this current invention is a back-lit curved light panel application and hydroponic garden system that can be wall-mounted, vertical and adjustable.

### BRIEF SUMMARY OF THE INVENTION

By providing a complete lighting and hydroponic gardening apparatus the objectives written above will be fulfilled.

The disclosed embodiments provide a plant growing device with vertical surfaces comprising two sides for plant growing access sites, the back side to be surface-mounted and the front side to be used for an artificial lighting application.

The embodiments of the two sides provide identical growing columns that share a central water circulatory system with a submersible pump and an internal tube and have access to artificial lighting.

In another embodiment, the rear side provides a vertical surface mountable frame that holds and connects the hydroponic garden and the lighting panel application.

In another embodiment the front side has curved panels with interior grow lights for controlled grow lighting in a vertical space. Further objects, features, advantages and properties of the apparatus will become apparent in the detailed description.

### BRIEF DESCRIPTIONS OF SEVERAL VIEWS OF THE DRAWING

In the following detailed portion of the present description, the teachings of the present application will be explained in more detail with reference to the example embodiments shown in the drawings, in which:

FIG. 1 is a perspective view of a hydroponic growth unit according to an embodiment of the invention;

FIG. 2 is a perspective view of the surface-mounted housing;

FIG. 3 is a front elevational view of the vertical modular hydroponic gardening tower and surface-mounted housing with plants;

FIG. 4 is an isometric view of a single module of the hydroponic gardening tower from FIG. 3;

FIG. 5 is a top plan view of a single module of the hydroponic gardening tower from FIG. 3;

FIG. 6 illustrates a vertical cross-section of a single module of the hydroponic gardening tower of line 104-5 from FIG. 5 with plants;

FIG. 7 is a right side elevation view of the hydroponic growth unit which is identical to the left side elevation;

FIG. 8 is a rear isometric view of the surface-mounted housing and curved lighting application;

FIG. 9 is a perspective view of the right curved lighting application and is identically mirrored to the left lighting application;

FIG. 10 illustrates a top plan view to an embodiment of the present invention in which demonstrates a plurality of positions of the curved-lighting application;

FIG. 11 illustrates a rear isometric view of the curved panel lighting application and surface-mounted housing as a static single piece;

FIG. 12 is a top plan view of the device of FIG. 11 which is identical to the bottom plan view of said device.

### DETAILED DESCRIPTION OF THE INVENTION

The above mentioned features of the invention will become more clearly understood from the following detailed description of the apparatus' embodiments with reference to the drawings, wherein like reference numerals are used to refer to like elements throughout. It should be noted that although only a hydroponic garden is described, the teachings of this application can also be used in other vertical planting applications, traditional soil-use gardening, and any other indoor plant growing applications. The embodiments described herein illustrate systems and methods for vertical hydroponic gardens that attempt to solve geometry problems for surface-mounted gardens with an integral lighting application.

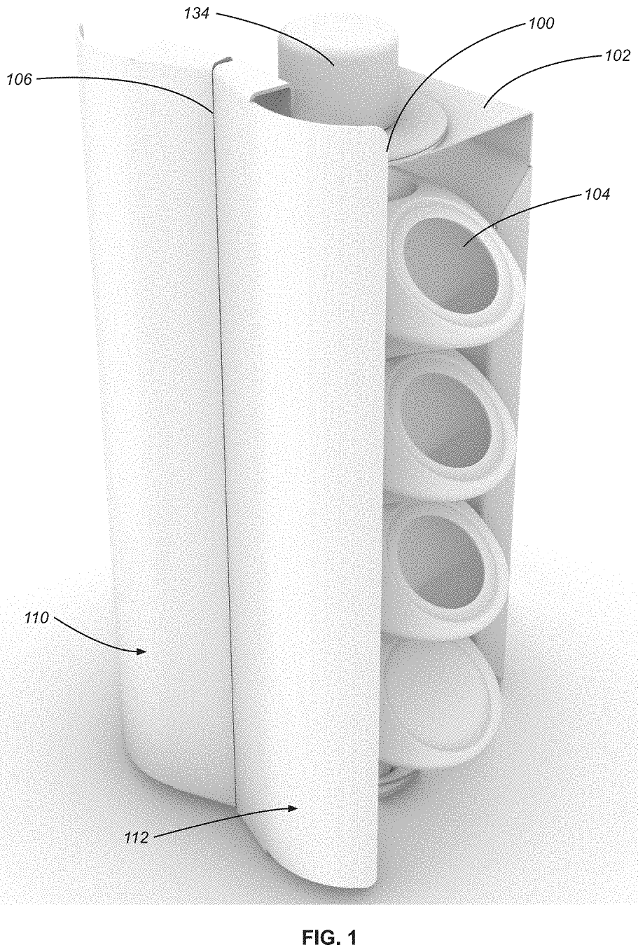

Thus, an embodiment of the hydroponic garden is illustrated in FIG. 1. The hydroponic garden 100 comprises a surface-mounted housing 102, a vertical modular hydroponic gardening tower 104 and a curved lighting application 106. The curved lighting application has a left panel 110 and a right panel 112, mirrored in shape and constructed of a rigid material.

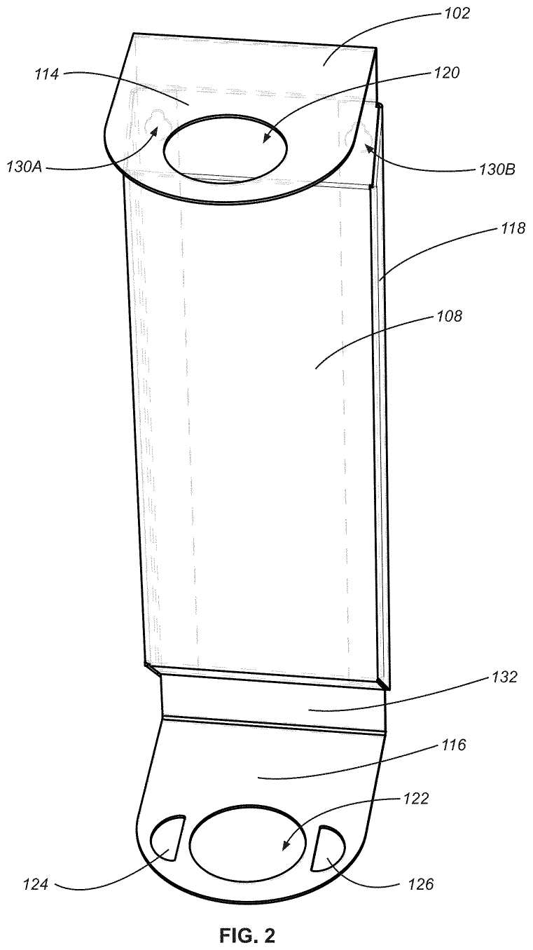

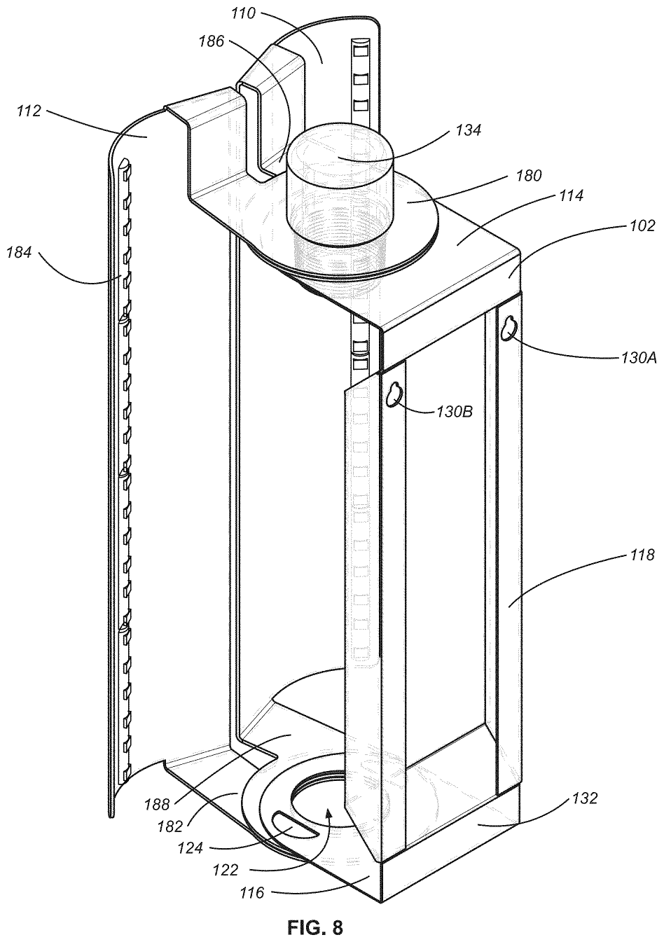

Referring to FIG. 2, the surface-mounted housing 102 comprises a front face 108, a top horizontal rigid surface perpendicular to the face 114, a bottom rigid surface perpendicular to the face 116, and a rear enclosure 118. The surface-mounted housing 102 is constructed from a rigid material with a reflective or metallic finish. The top horizontal surface 114 and bottom horizontal surface 116 are cut with a top circular hole 120, a bottom circular hole 122 and mirrored half circular holes 124, 126 to secure the vertical modular tower 104. Referring to FIG. 8, the rear enclosure 118 comprises a left rear hole 130A and right rear hole 1306 in the rigid material for wall-mounting. The bottom of the front face 108 is bent so that another parallel surface 132 can align to the mounting surface.

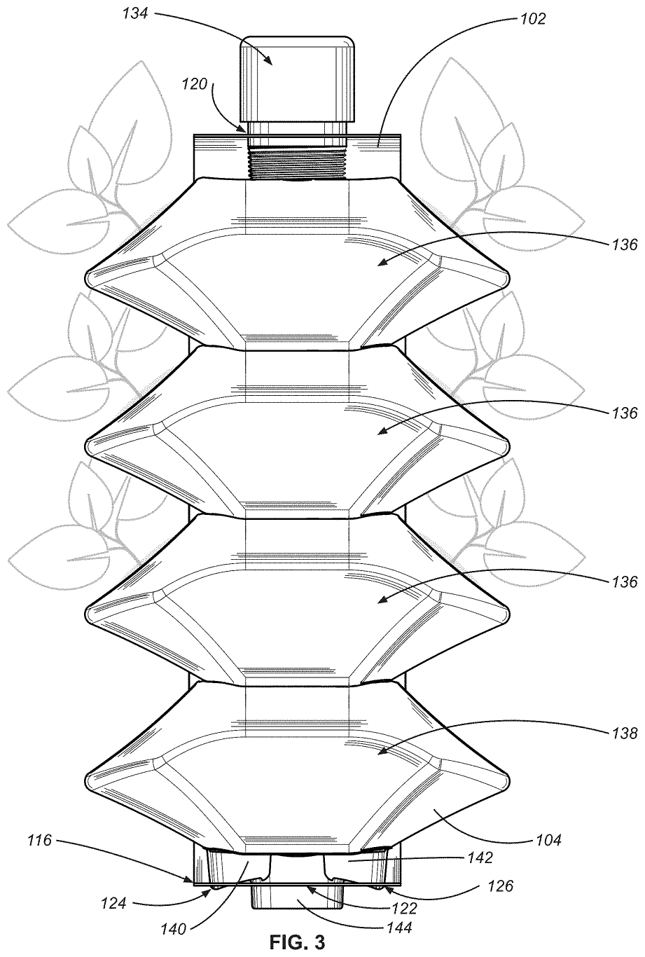

Referring to FIG. 3, the vertical modular hydroponic gardening tower 104 and surface-mounted housing 102 are shown with plants. A screw end cap 134 comes down into the hydroponic tower 104 through the top circular hole 120. The hydroponic tower 104 comprises multiple hollow dual plant growth site modules 136 and similarly shaped water reservoir module 138. The bottom-most hollow module 138 comprises a bottom left curved extrusion 140, a mirrored right extrusion 142 and a cylindrical extrusion 144. These bottom extrusions 140, 142, 144 fit into the holes 122, 124, 126 of the bottom perpendicular surface 116.

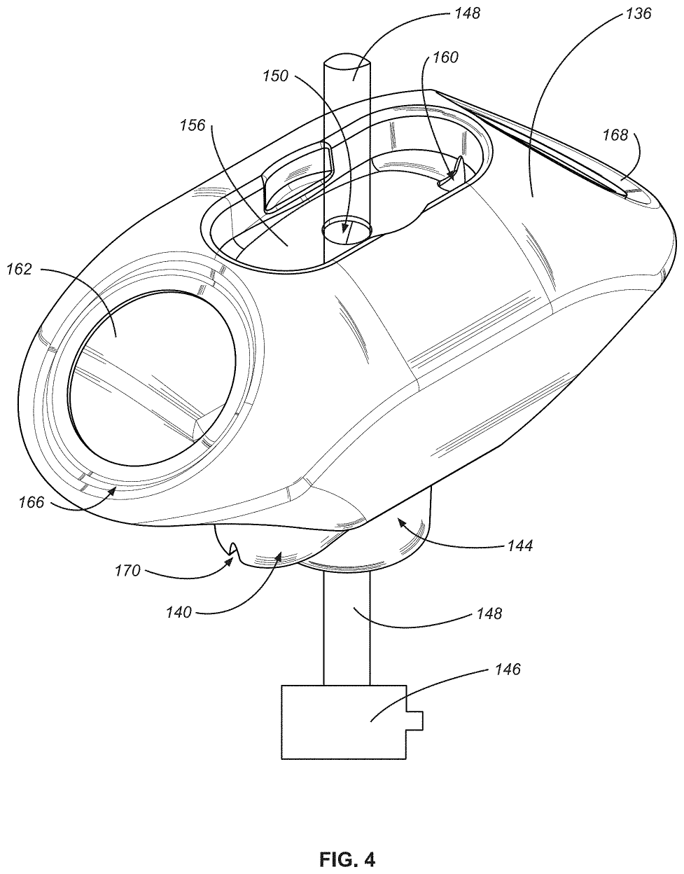

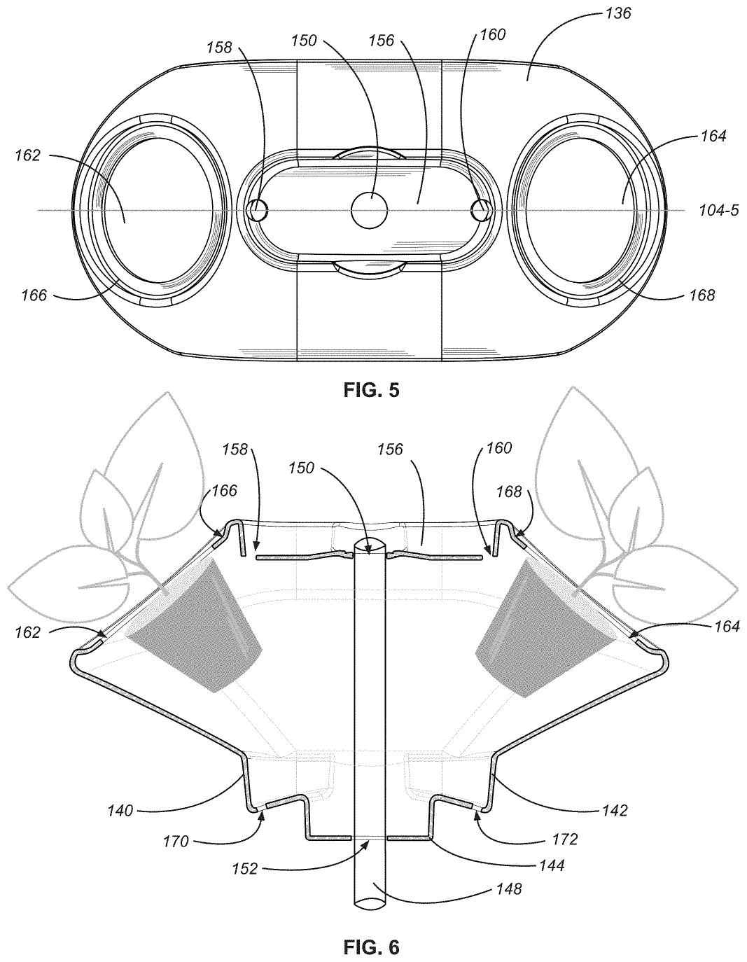

The vertical modular hydroponic gardening tower is constructed from a set of hollow modules made of a rigid material. Referring to FIG. 4, a submersible water pump 146 and a single vertical tube 148 run from the bottom through the plant growing module(s) 136. The vertical tube 148 is constructed of a flexible plastic material and will be guided through each module via the top centered circular hole 150 and a bottom circular hole 152 as shown in FIG. 6. The bottom-most module 138 of the hydroponic tower 104 will hold the submersible pump 146 and distribute nutrient-soluble water up the vertical tube 148 to the top-most module 136.

Water is brought to the top depression well 156 and dispensed down the left opening 158 and the right opening 160. The water is directed from those openings 158, 160 to the respective side of plant grow materials inserted through access holes 162, 164. Those access holes 162, 164 are angled to give plants access to water internally and the external lighting application 106. Identical circular recessed lips on the left 166 and right side 168 are shown in FIG. 6. Excess water off the plant grow materials runs down the left and right side respectively to a left drain hole 170 and right drain hole 172 of the plant growing module 136. Excess water will eventually run down through each plant growth module and return to the water reservoir 138 and be recirculated again.

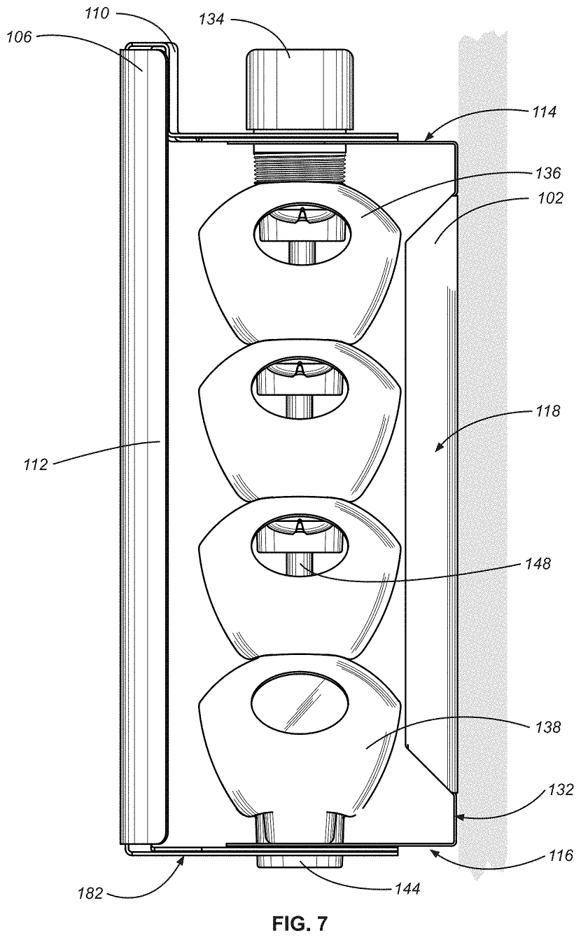

Another embodiment of the hydroponic garden is shown in FIG. 7. The hydroponic garden 100 is surface mountable via the housing 102 using any type of picture hanging equipment or with a screw and anchor into an interior wall through the rear enclosure 118 with holes 130A, 130B. The lighting application runs parallel to the front face 118 and the mounted surface.

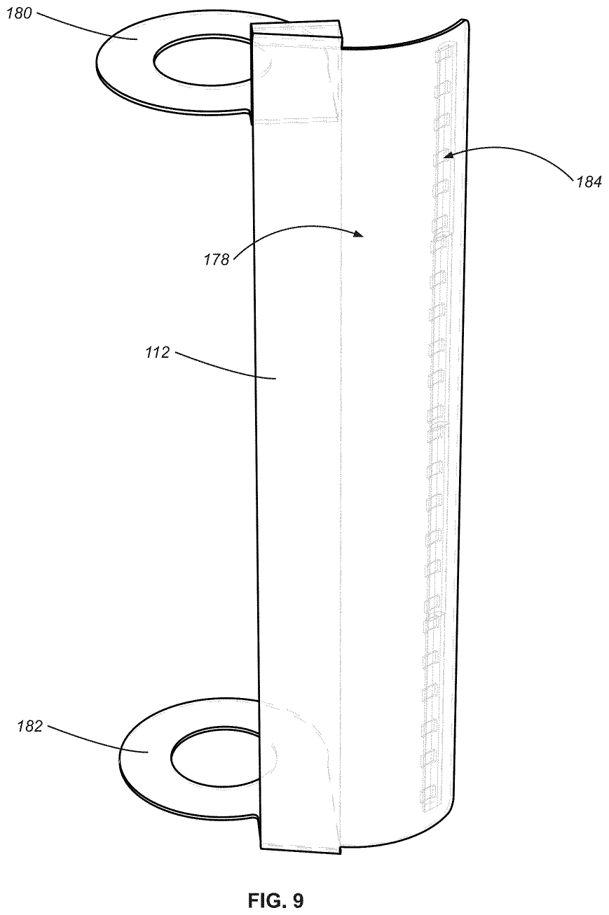

Another embodiment of the hydroponic garden is shown in FIG. 9. The right side panel 112 of the curved lighting application 106 consists of a convex front face 178, top perpendicular circular flange support 180, a bottom perpendicular circular flange support 182 and an interior vertical LED lighting strip 184. The top flange support 180 is identically mirrored by the top flange support 186 of the left lighting panel 110. As shown in FIG. 8, the light panels 110, 112 extend above the top housing perpendicular surface 114 and the flanges 180, 186 are bent to meet the housing. The screw cap 134 fits down into the flanges 180, 186 and secured into the housing through the top circular hole 120.

Referring to FIG. 7, the bottom perpendicular surface 116, the bottom cylindrical extrusion 144 of the modular growing tower secures the bottom circular flange 182 and the identical mirrored flange 188 of the left panel 110. The end cap 134 and bottom cylindrical extrusion 144 are identical in diameter allowing the light panels 110, 112 to rotate on those flanges 180, 186.

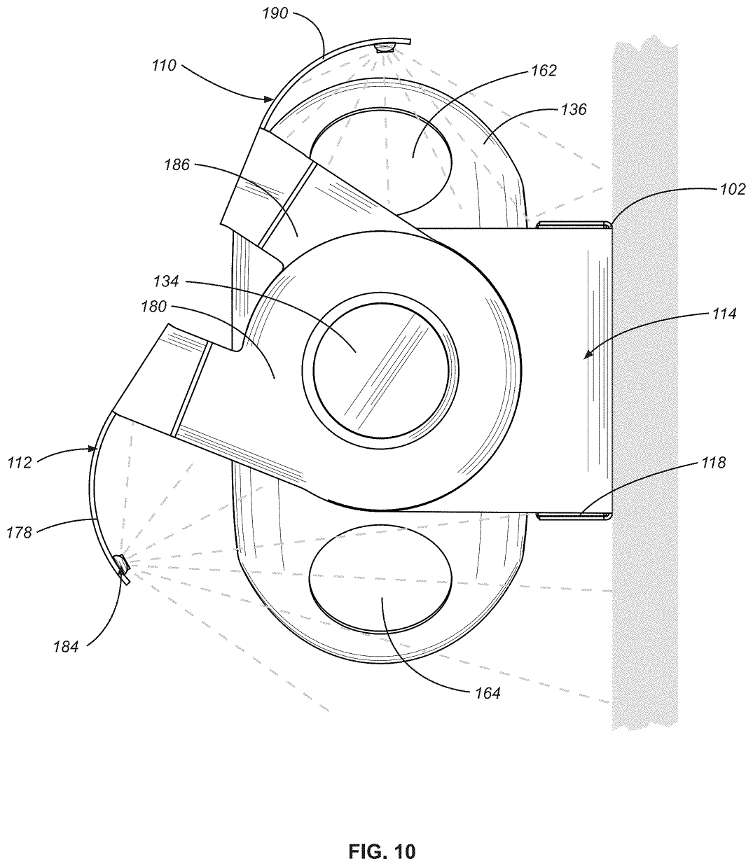

Shown in FIG. 10, the light panels 110,112 are adjusted along the horizontal axis by rotating those flanges 180, 186. The front faces 178, 190 are curved towards the plant access sites 162,164.

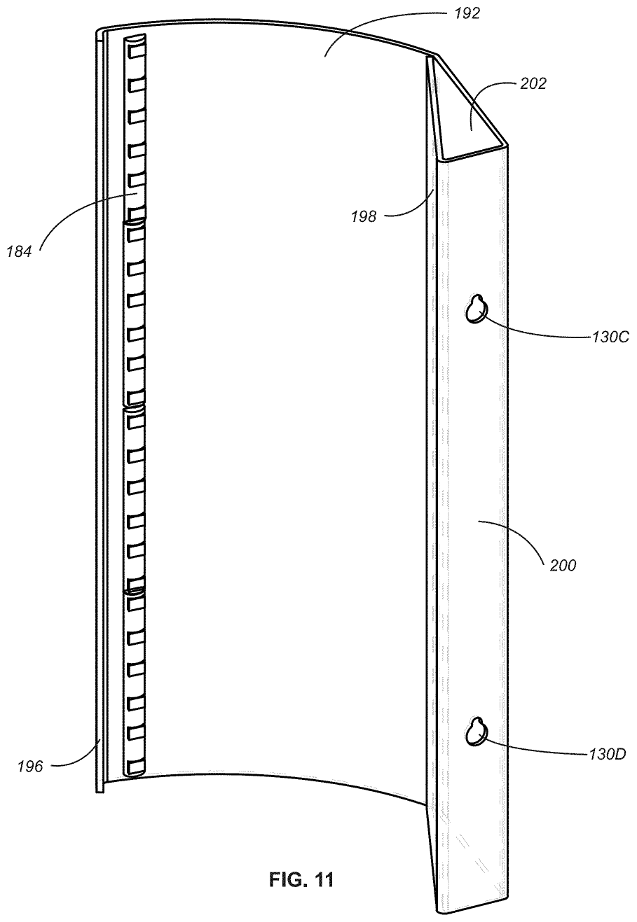

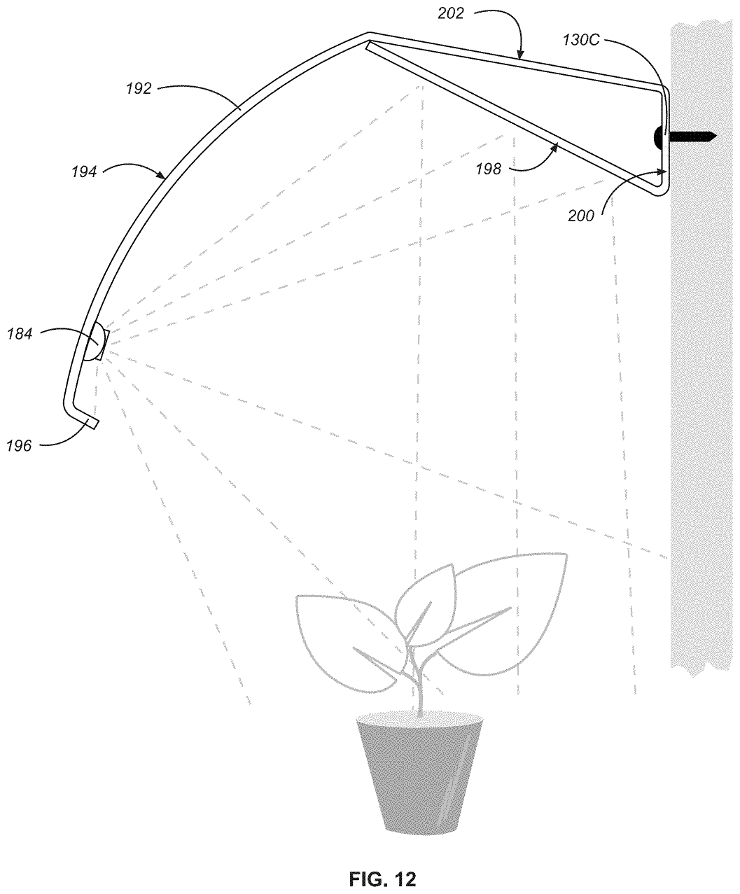

A wall-mounted plant grow light 192 is shown in FIG. 11, in which the previous embodiments of the lighting application 106 and the surface-mounted housing 102 are combined for a single rigid and material piece with the vertical lighting strip 184. The wall-mounted plant grow light 192 comprises rear holes 130C, 130D, curved front face 194, vertical lip 196, interior flat face reflector 198, rear wall 200, and flat side wall 202. The wall-mounted grow light 192 is constructed of a rigid material so that the interior flat face reflector 198 has a reflective surface. As shown in FIG. 12, the vertical lip 196 blocks some light rays from the vertical lighting strip 184 and a plant is used to show direction and focus of the lighting application. The rear wall comprises a top rear hole 130C and right rear hole 130D in the rigid material for wall-mounting. The flat side wall 202 connects the mountable housing to the curved lighting panel 194.

Having thus described the aforementioned invention, I claim:

1. A vertical plant cultivation system for growing in an indoor environment, said apparatus comprising:
(a) a set of hollow planting modules having a plurality of plant site holes to receive porous plant grow mediums;
(b) a reservoir for holding fluid;
(c) a submersible water pump and supply tubing;
(d) means for supporting plant growth through a circulating nutrient soluble water system whereby fluid is transported from the water reservoir through a centered supply line and dispersed down to the plant site holes;

2. The plant cultivation system of claim 1, wherein said modules comprise dual symmetrical plant site holes, a centered embossed top with drain holes, a central hole to engage the water distribution.

3. The apparatus of claim 2 wherein the module of the plant cultivation system comprises plant access holes angled to access light and provide fluid to porous plant grow mediums.

4. The apparatus of claim 2 wherein the embossed top comprises symmetrical holes cut and centered above the plant site holes to transport water directly to that grow medium.

5. The apparatus of claim 2 wherein the drain holes will direct water to reach grow medium reducing the sound of fluid splashing.

6. A plant cultivation system for growing in an indoor environment, said apparatus comprising:
(a) a hydroponic gardening tower with symmetrical sides of plant access site holes;
(b) An artificial grow lighting application;
(c) a surface-mountable apparatus for hanging on a vertical surface;

7. The plant cultivation system of claim 6, wherein said mounting apparatus comprises a large vertical surface face parallel to the planting column, rear holes for mounting to a vertical surface, an interior housing for electrical connections between the surface mountable apparatus and the mounting surface and dual horizontal support surfaces.

8. The apparatus of claim 7, wherein the vertical surface face provides a barrier between the planting column, the electrical connections and the mountable surface.

9. The apparatus of claim 7, wherein said dual horizontal supports secure the planting column.

10. The apparatus of claim 7, wherein said two perpendicular supports secures the lighting application.

11. A plant cultivation system for growing in an indoor environment, said apparatus comprising:
(a) a hydroponic gardening tower with symmetrical sides of plant site holes;
(b) a surface-mountable apparatus;
(c) a pair of grow lights;
(d) a pair of grow lighting panels;

12. The plant cultivation system of claim 11, wherein said pair of identical light panels comprise of at least one flange to rotate on the surface-mountable apparatus.

13. The plant cultivation system of claim 11, wherein said light panels comprise convex front faces.

14. The light panels of claim 11, wherein the grow lighting panels cover the front elevation of the hydroponic gardening tower.

15. The light panels of claim 11, wherein the interior concave space utilizes vertical lighting.

16. The light panels of claim 11, wherein the concave shape reflects the light between wall-mountable base and the interior surface of the light panel.

17. The light panels of claim 11, wherein the interior concave shape focuses light towards plants in proximity to the mounted surface.
